(19) United States
(12) Patent Application Publication
(10) Pub. No.: US 2026/0049629 A1
(43) Pub. Date: Feb. 19, 2026

(54) REMOVABLE PIN AND SET SCREW JOINERY

(71) Applicant: SPECIAL-T, LLC, Alpharetta, GA (US)

(72) Inventors: Alex WIEDENMANN, Alpharetta, GA (US); Justin CALVERY, Alpharetta, GA (US); Ventsislav DRANDEV, Sevlievo (BG)

(21) Appl. No.: 19/269,595

(22) Filed: Jul. 15, 2025

Related U.S. Application Data
(60) Provisional application No. 63/671,658, filed on Jul. 15, 2024.

(51) Int. Cl. F16B 12/10; F16B 12/44

(52) U.S. Cl. CPC F16B 12/10; F16B 12/44

(57) ABSTRACT

A connector assembly for joining together parts of an apparatus, such as a piece of a furniture, includes a mounting pin with a recessed portion integrated or coupled to a first part and second part having a hole through which a set screw passes and joins the second part to the first part when the set screw locks into the recessed portion of the mounting pin.

### CROSS-REFERENCE TO RELATED APPLICATION

This application claims the benefit of priority to U.S. Provisional Application No. 63/671,658 and entitled “REMOVABLE PIN AND SET SCREW JOINERY,” filed Jul. 15, 2024, the disclosure of which is hereby incorporated by reference herein in its entirety for all purposes.

### BACKGROUND OF THE INVENTION

The present invention relates to improved connector assemblies for parts that are joined together, such as furniture feet and runners to a support column of tables, chairs and the like.

### SUMMARY OF THE INVENTION

In one embodiment of the invention, a support column includes a mounting pin with a recessed portion for receiving a set screw through a furniture part that is fastened to the mounting pin on the support column.

In embodiments, the mounting pin screws on to a threaded bolt that is coupled to the support column. In various embodiments the threaded bolt may be secured to the column by a locking connector, such as a threaded nut or threaded connector having a tapped or threaded hole receives the threaded bolt into a hollow column. In other embodiments, the support column may have tapped or threaded holes that receive the threaded bolt there I the support column wall is thick enough to have a hole with threads. In such embodiments, the mounting pin includes a threaded hole that screws on to the threaded bolt for securing the mounting pin to the support column. Multiple mounting pins may be similarly secured to the support column to permit attachment of multiple parts to the support column, i.e., each mounting pin can be attached a respective furniture part, such as multiple feet to a table support column.

In other embodiments, a mounting pin can be fabricated, welded or otherwise provide on a support column without a separate bolt fastener to which the mounting pin attaches. In other embodiments, the mounting pin can include a threaded integral bolt portion and screw into a threaded hole or tapped hole of a support column or mate with a threaded locking nut or similar connector.

In further embodiments, a mounting pin need not necessary be coupled or integrated to support columns of a furniture unit, but can be coupled to or integrated on other manufactured parts like a first part that connects to another complementary second part through which a set screw passe and secures the second part to the first part as the set screw locks into a recessed portion or threaded portion of the mounting pin.

Embodiments of the invention utilizing joinery with a mounting pin of a first part of a support column to which a set screw joins a second part to the first part or support column permit parts to be more easily separated for repair or replacement, or for providing interchangeable selections of different parts, such as having different materials, finishes and colors, with one another while having an advantage of easy assembly.

### BRIEF DESCRIPTION OF THE DRAWINGS

FIG. 1 is perspective view of a first part of a furniture column including a threaded bolt and mounting pin with a recess in an embodiment of the invention.

FIG. 2 is perspective view of a first part of a furniture column including a threaded bolt and mounting pin with a recess and second part of furniture foot with a set screw in an embodiment of the invention.

FIG. 3 is perspective view of a first part of a furniture column including a threaded bolt and mounting pin with a recess and second part of furniture foot with a set screw in an embodiment of the invention.

FIG. 4 is perspective view of a first part of a furniture column including a threaded bolt and second part of furniture foot with a set screw secured to recess (hidden) of a mounting pin (hidden) in an embodiment of the invention.

FIG. 5 is perspective view of a first part including a mounting pin with a recess and second part with a set screw in an embodiment of the invention.

FIG. 6 is perspective view of a first part of a furniture column including a mounting pin with a recess and second part of furniture foot with a set screw in an embodiment of the invention.

FIG. 7 is perspective view of a first part of a furniture column including a mounting pin with a recess and second part of furniture foot with a set screw in an embodiment of the invention.

FIG. 8 is perspective view of a first part of a furniture column coupled to a second part of furniture foot in an embodiment of the invention.

FIG. 9 are schematic views of a mounting pin in an embodiment of the invention.

FIG. 10 is a perspective exploded view of a first part, threaded bolt, mounting pin with recess and locking fastener in an embodiment of the invention.

FIG. 11 are schematic views of a first part having a threaded bolt, mounting pin with recess and second part with a set screw in an embodiment of the invention.

FIG. 12 are schematic views of a second part of furniture foot having a set screw.

FIG. 13 is a cross-section view of a first part having a threaded bolt, mounting pin with recess and second part with a set screw in an embodiment of the invention.

FIG. 14 is perspective view of a first part with mounting pins and second part in an embodiment of the invention.

FIG. 15 is perspective view of a first part with mounting pins having a recess and second part in an embodiment of the invention.

### DESCRIPTION OF THE INVENTION

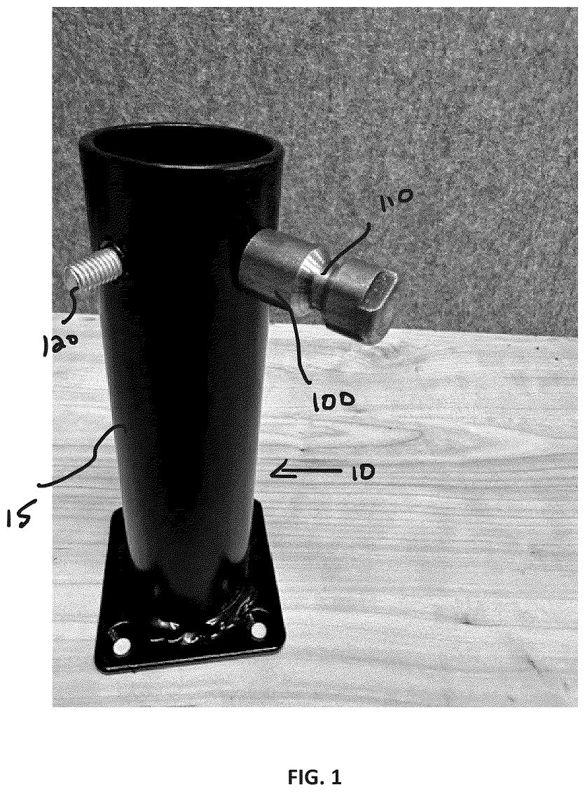

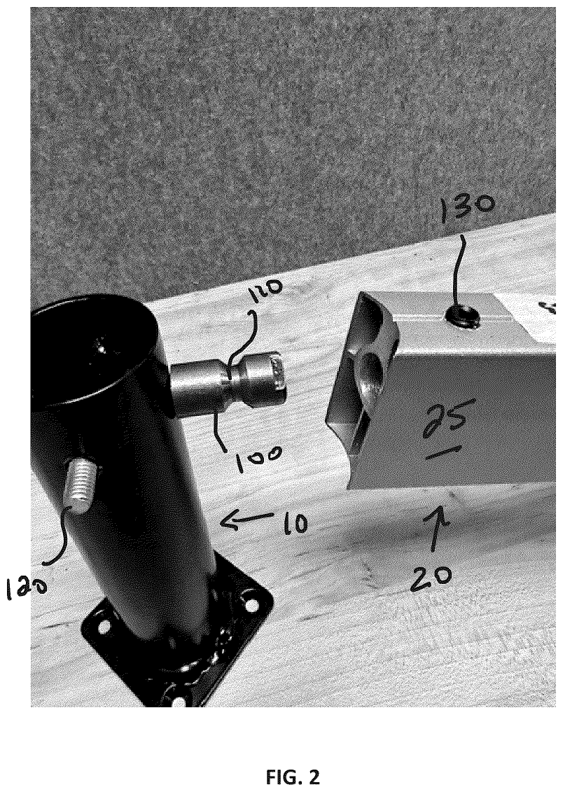

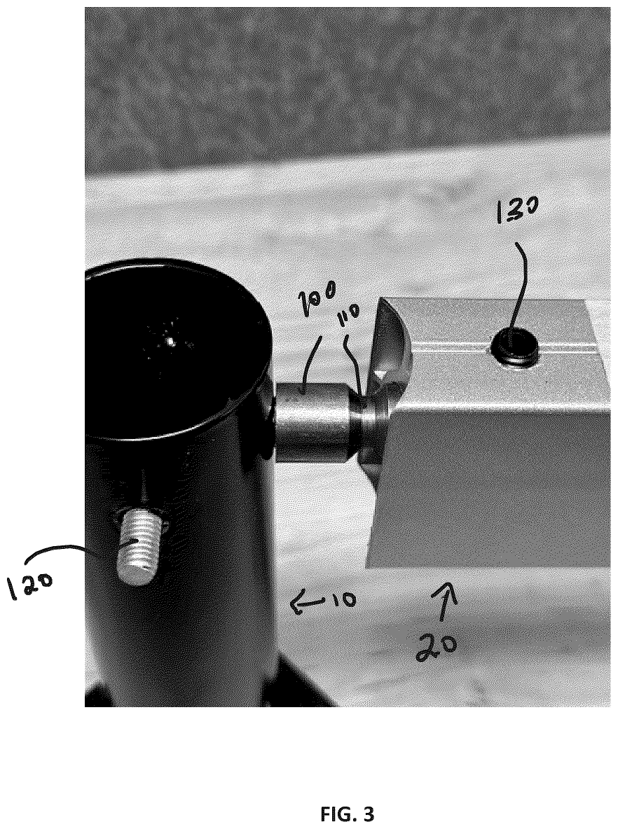

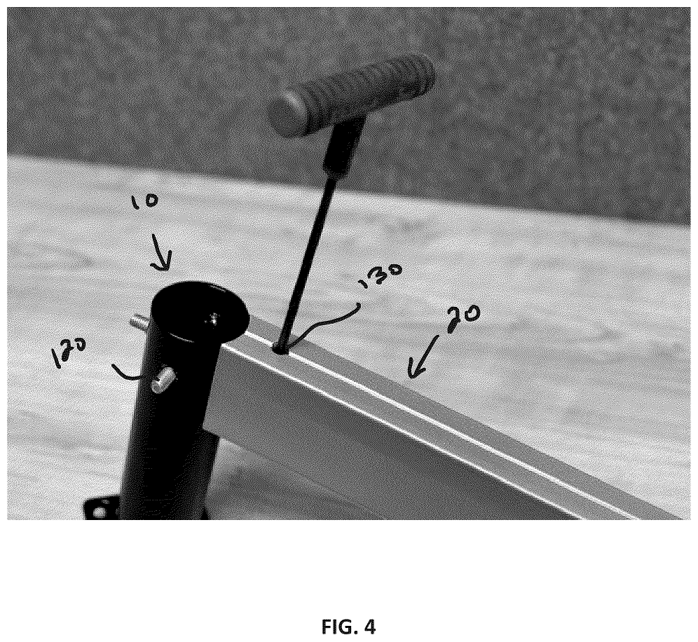

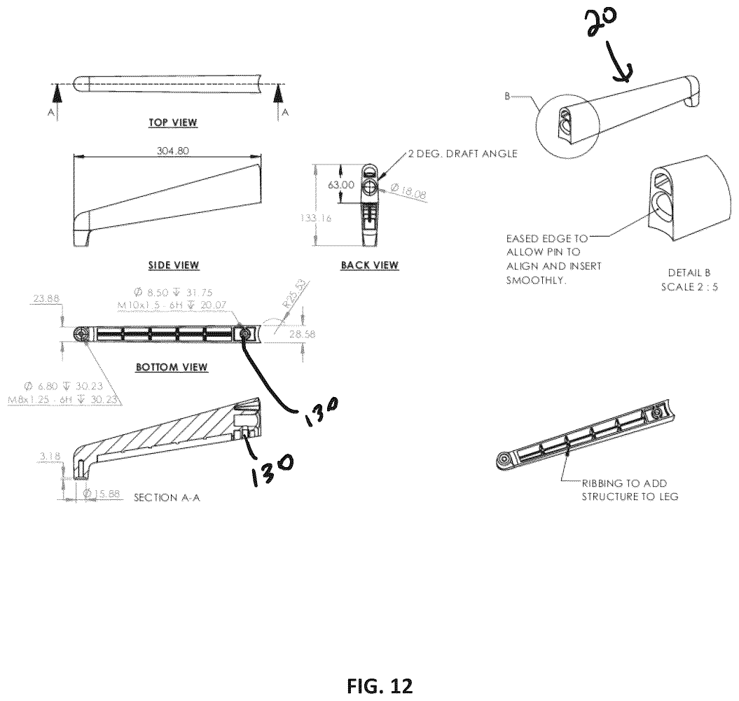

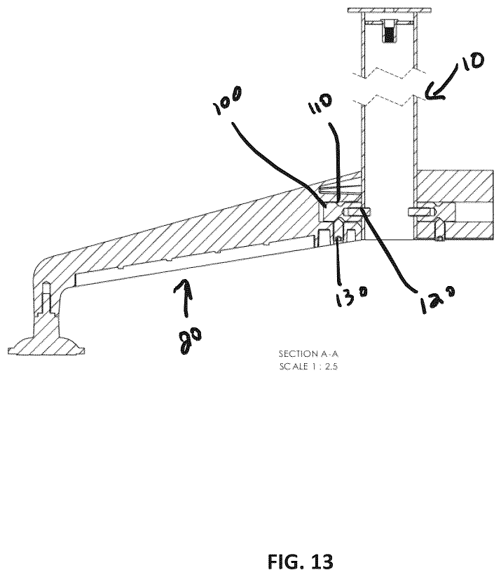

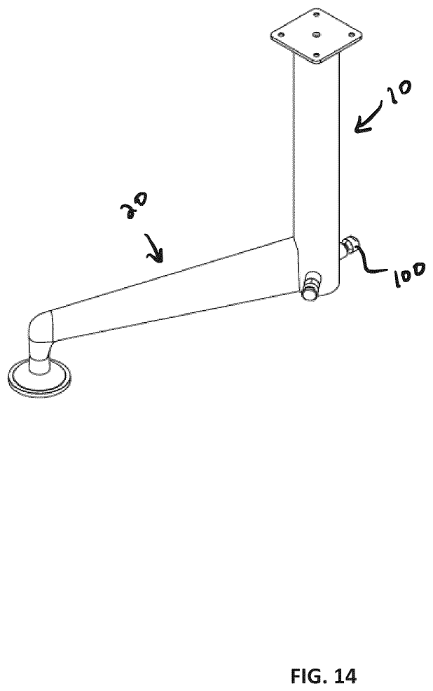

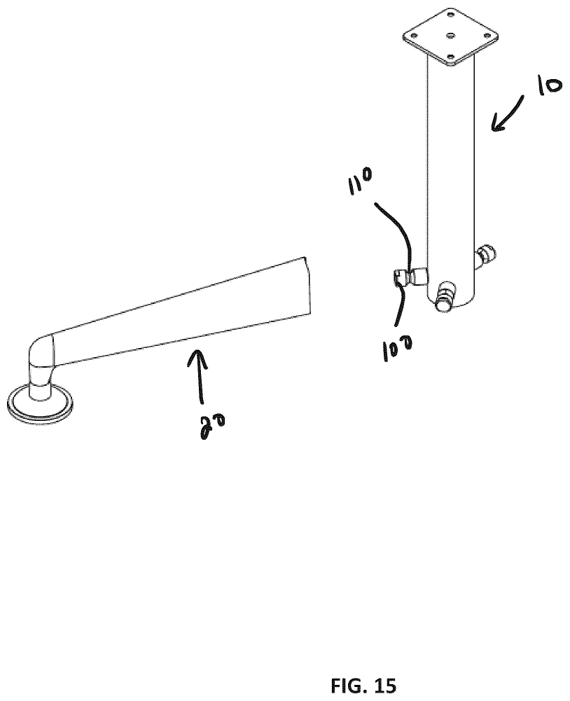

FIGS. 1-4 and 12-15 illustrate a furniture support column 15 as a first part 10, such as of a table, chair, credenza and the like, including a mounting pin 100 with a threaded interior that fastens on to a threaded bolt 120 to secure the mounting pin 100 to the support column 15 and a second part 20, such as a furniture foot 25, having a set screw 130 (such as pre-provided in a fastening hole of the furniture foot for easy assembly by a user), that couples to the mounting pin 100, such as into a recessed portion 110 around the mounting pin 100 that receives the threaded set screw 130, in an embodiment of the invention.

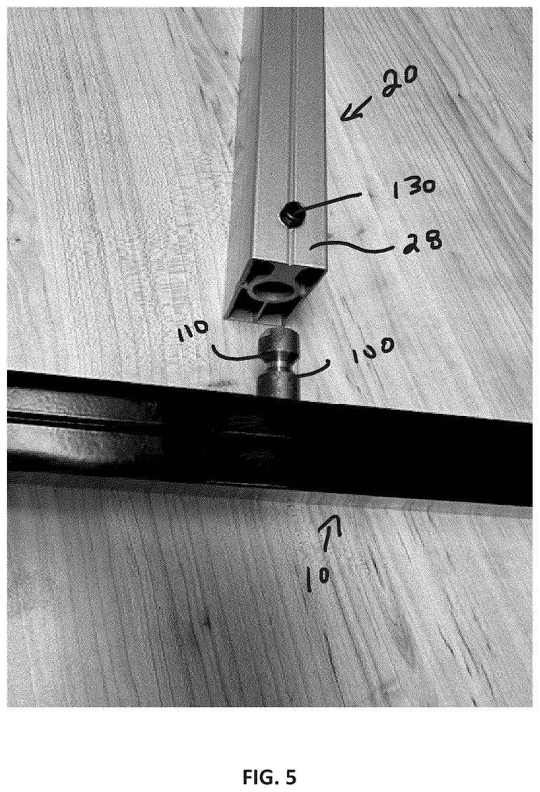

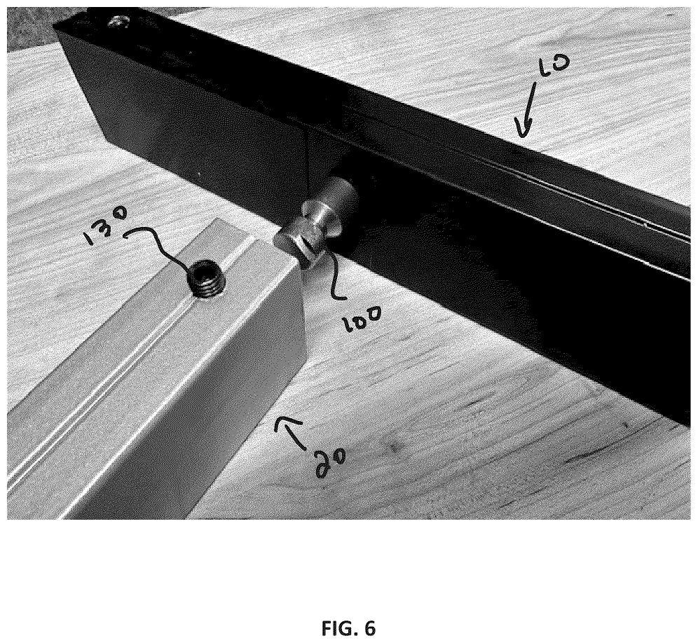

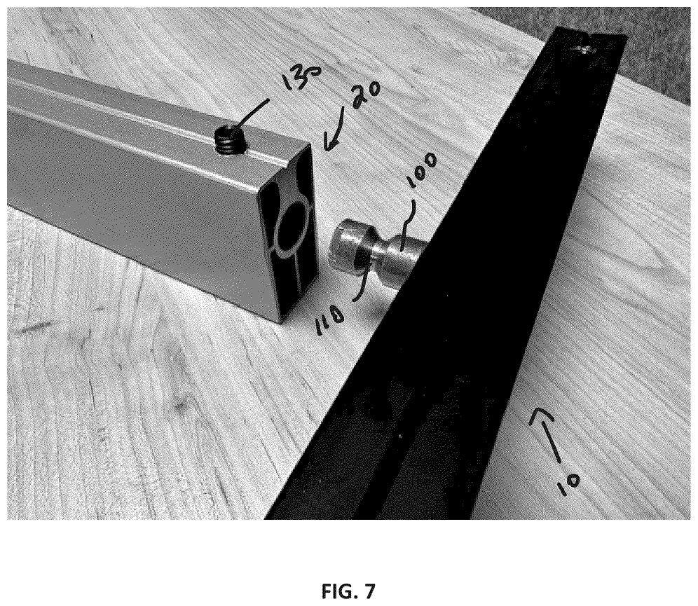

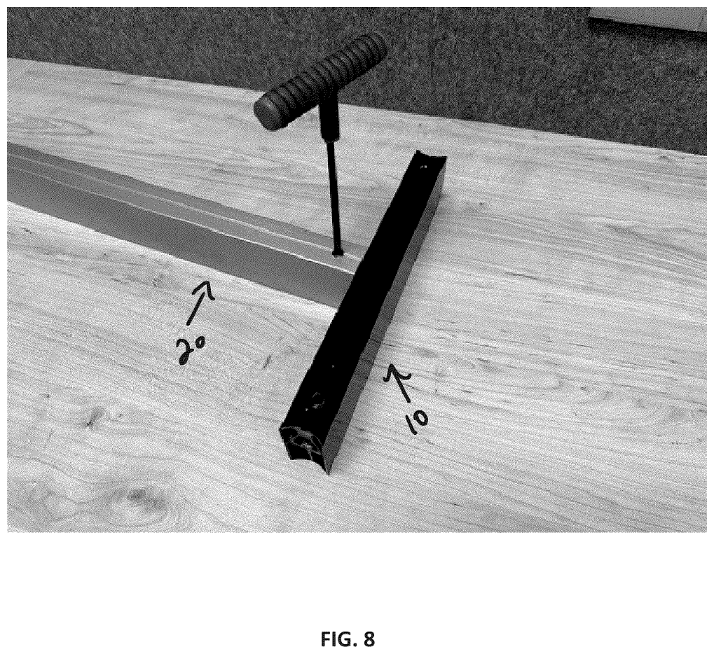

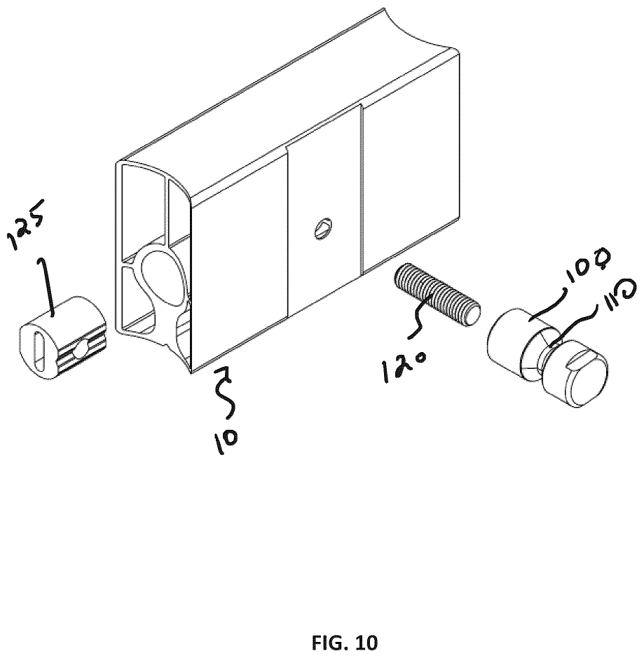

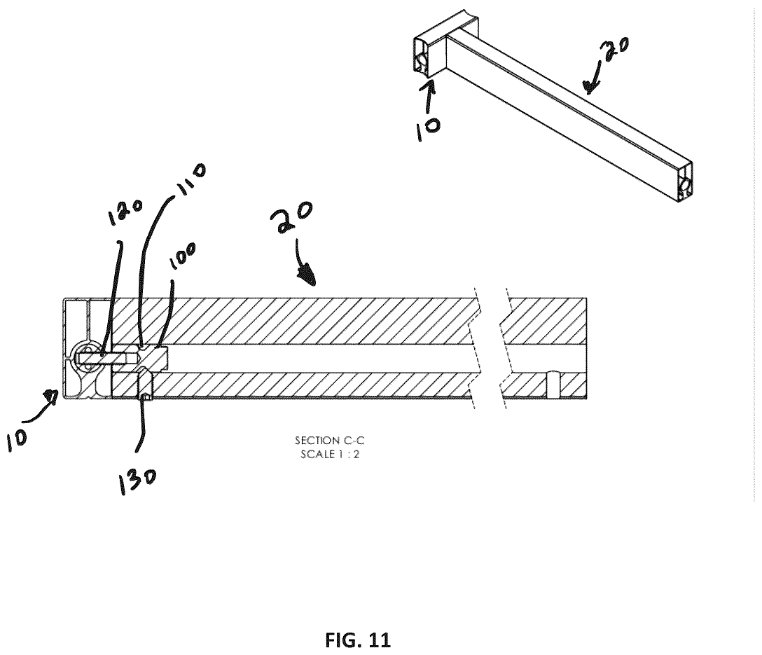

FIGS. 5-8, 10 and 11 illustrate a first part 10 including a mounting pin 100, such as having a threaded interior that fastens on to a threaded bolt 120 to secure the mounting pin 100 to the first part 10 and a second part 20, such as runner assembly 28, having a set screw 130 (such as pre-provided in a fastening hole of the second part 20 for easy assembly by a user), that couples to the mounting pin 100, such as into a recessed portion 110 around the mounting pin 100 that receives the threaded set screw 130, in an embodiment of the invention. Referring to FIG. 10, in some embodiments threaded bolt 120 couples to a locking fastener 125 through first part 10 to secure threaded bolt 120 and mounting pin 100 to first part 10.

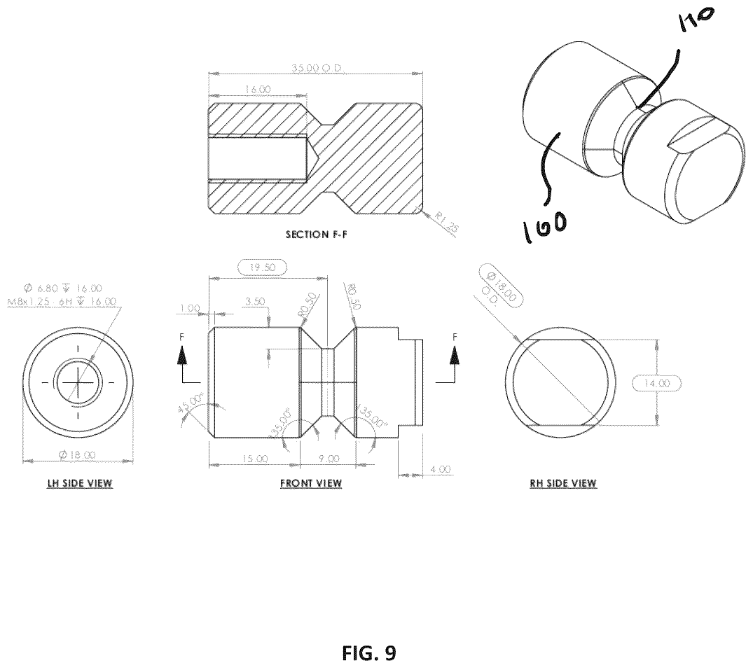

FIG. 9 illustrates a mounting pin 100 in an embodiment of the invention.

Various embodiments of the invention have been described. It will, however, be evident that various modifications and changes may be made thereto, and additional embodiments may be implemented, without departing from the broader scope of the invention as set forth by the claims. This specification is to be regarded in an illustrative rather than a restrictive sense.

What is claimed is:

1. A connection assembly to join a first part and second part comprising:
the first part including a mounting pin with a recessed portion configured to receive a set screw;
the second part including a hole including the set screw therethrough to fasten the second part to the first part.

2. The connection assembly of claim 1, further comprising a threaded bolt coupled to or integrated with the first part and configured to removably couple to the mounting pin.

3. The connection assembly of claim 2, wherein the first part is a support a column of a piece of furniture.

4. The connection assembly of claim 3, wherein the second part is a foot of the piece of furniture.

5. The connection assembly of claim 4, wherein the piece of furniture is one of a table, chair, credenza, bench, stand, storage unit, dresser, bed, cubicle wall, divider wall and cabinet.

6. The connection assembly of claim 1, wherein the second part is a runner assembly.

7. The assembly of claim 6, wherein the runner assembly is a part of furniture.

8. The assembly of claim 2, further comprising a locking fastener coupling the threaded bolt to the first part.

9. The assembly of claim 3, further comprising a locking fastener coupling the threaded bolt to the first part.

10. The assembly of claim 4, further comprising a locking fastener coupling the threaded bolt to the first part.

11. The assembly of claim 5, further comprising a locking fastener coupling the threaded bolt to the first part.

12. The assembly of claim 1, wherein the mounting pin is integrated on the first part.

13. The assembly of claim 1, wherein the mounting pin removably couples to the first part.
